(19) United States
(12) Patent Application Publication
(10) Pub. No.: US 2020/0242574 A1
(43) Pub. Date: Jul. 30, 2020

(54) Asset Sharing Blockchain

(71) Applicant: Beijing Mercatusion Technology Ltd, Beijing (CN)

(72) Inventor: Naijie Zhou, Chengdu (CN)

(21) Appl. No.: 16/747,570

(22) Filed: Jan. 21, 2020

(30) Foreign Application Priority Data
Jan. 28, 2019 (CN) 201910077479.1

(51) Int. Cl. G06Q 20/06; G06Q 20/02; G06Q 20/10; H04L 9/06; G06Q 20/36

(52) U.S. Cl. CPC G06Q 20/0658; G06Q 20/02; G06Q 20/105; H04L 2209/56; G06Q 20/3678; H04L 2209/38; H04L 9/0637

(57) ABSTRACT

An asset sharing blockchain is provided, including multiple nodes serially connected using blockchain technology. Each node may include an access interface available for call by another asset sharing blockchain and a repository storing data, a smart contract code and a computation result available for call by another asset sharing blockchain.

### CROSS-REFERENCE TO RELATED APPLICATIONS

The present disclosure claims priority of Chinese Patent Application No., 201910077479.1, filed to China Patent Office on Jan. 25, 2019. Contents of the present disclosure are hereby incorporated by reference in entirety of the Chinese Patent Application.

### TECHNICAL FIELD

The present disclosure relates to the technical field of blockchain technology, and in particular to an asset sharing blockchain.

### BACKGROUND

Blockchain technology is an emerging technology in recent years. Blockchain technology has the features of decentralization and is able to ensure that stored transaction data will not be forged or falsified. Therefore, blockchain technology is increasingly a target for application on multiple technical fields. In most conventional blockchain systems, when a new application is implemented, a variety of problems may occur. For instance, data and smart contracts on existing applications cannot be directly referenced. Even when the source data, source code or computation results from previous applications can be referenced, the validity of the acquired data cannot be ensured, and as a consequence the output of applications cannot be ensured.

### SUMMARY

As to the above mentioned problem, at least some embodiments of the present disclosure describe an asset sharing blockchain, so as at least to partially solve the problem in the related art.

In an embodiment of the present disclosure, an asset sharing blockchain may include multiple nodes serially connected using blockchain technology. Each node may include an access interface available for call by another asset sharing blockchain, a repository for storing data, a multitude of smart contracts and a repository for storing computation results. Each of which is provided in a manner available for call by another asset sharing blockchain.

In another embodiment of the present disclosure, an asset sharing blockchain may include at least two blockchains. Each of these blockchains may include multiple nodes serially connected using blockchain technology, and each node may include an access interface available for call by another asset sharing blockchain and a repository for storing computation results. Each of which is provided in a manner available for call by another asset sharing blockchain.

In some optional embodiments, the data, the smart contract code and the computation result can be called by the same asset sharing blockchain, or the data, the smart contract code and the computation result can be called by different asset sharing blockchains.

In some optional embodiments, the asset sharing blockchain receives data and smart contract code from other sources and distributes the data to the multiple nodes to each respectively compute part of the data.

In some optional embodiments, the asset sharing blockchain implements a currency value regulatory mechanism, including the following steps.

The currency value and the market scale of the asset sharing blockchain of a given round are validated.

The monetary supply issued by the asset sharing blockchain of the given round are validated.

The monetary supply of a following round is estimated.

The historical currency value and an actual monetary supply of a current round on the asset sharing blockchain of the given round are validated.

The monetary supply difference is obtained according to an estimated monetary supply of the previous round and the actual monetary supply of the given round.

The currency value of the following round is determined according to the monetary supply difference of the given round.

In some optional embodiments, each token on the asset sharing blockchain has an exclusive code.

In summary, at least some embodiments of the present disclosure provide an asset sharing blockchain which is able to provide the stored data, the smart contract code and the computation result available for call by at least one other asset sharing blockchain, and may share a computing asset with the at least one other asset sharing blockchain, so that development cost and the computing asset may be distributed across nodes, and the authenticity of data sources and code may be ensured. In addition, the currency value may further be adjusted, so as to balance a currency value relationship between different asset sharing blockchains.

### BRIEF DESCRIPTION OF THE DRAWINGS

FIG. 1 is a block diagram of an asset sharing blockchain according to the first optional embodiment of the present disclosure.

FIG. 2 is a flow diagram of a currency value regulatory mechanism according to the embodiment of the present disclosure.

FIG. 3 is a block diagram of an asset sharing blockchain according to the second optional embodiment of the present disclosure.

### DETAILED DESCRIPTION

In order to make the aforementioned purposes, features and effects of the present disclosure more easily understood, embodiments and drawings for describing the present disclosure in detail have been provided below.

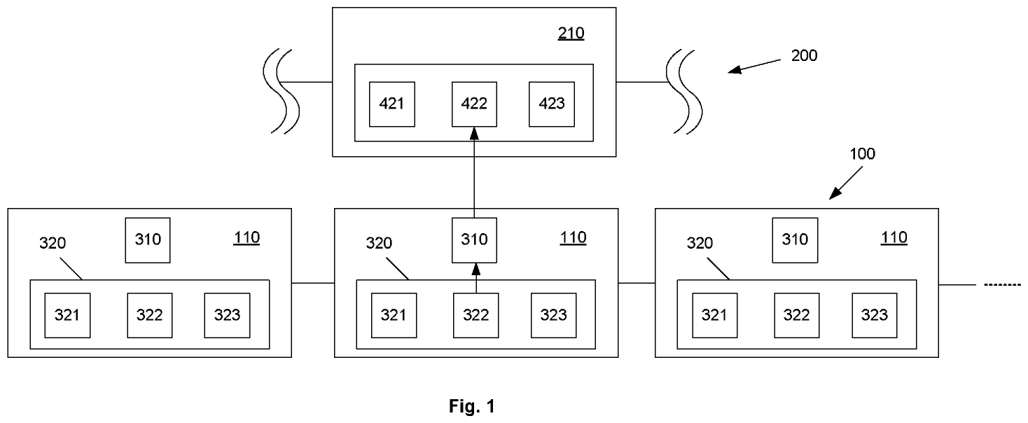

As shown in FIG. 1, FIG. 1 is a block diagram of an asset sharing blockchain according to the first optional embodiment of the present disclosure. The asset sharing blockchain may include an asset sharing blockchain 100. The asset sharing blockchain 100 may include multiple nodes 110 serially connected using blockchain technology. Each node 110 may include an access interface 310 available for call by another asset sharing blockchain 200 and a repository 320 storing data 321, a smart contract code 322 and a computation result 323 available for call by the asset sharing blockchain 200. In some optional embodiments, the repository 320 may be structured database, such as Sql server, Oracle or MySql. In some optional embodiments, the repository 320 may be an unstructured database, such as NoSql or MongoDB. In some optional embodiments, the repository 320 may be a memory cache. The access interface 310 defines a standard access mode, so as to allow the asset sharing blockchain 200 access to each node of the asset sharing blockchain 100. In some optional embodiments, the asset sharing blockchain 200 may be another asset sharing blockchain 100. In other words, the asset sharing blockchain may include more than two asset sharing blockchains 100 and asset sharing blockchains 200.

When the asset sharing blockchain 200 is interfaced with the asset sharing blockchain 100, exchange of tokens and assets may be agreed through a smart contract on the asset sharing blockchain 100. That is, the asset sharing blockchain 200 provides the asset sharing blockchain 100 with at least one token, and the asset sharing blockchain 100 provides the asset sharing blockchain 200 with the aforementioned asset (namely, at least one of the data 321, the smart contract code 322 and the computation result 323) for use. As shown in FIG. 1, for example, the asset sharing blockchain 200 may call the smart contract code 322 of the asset sharing blockchain 100, take this smart contract code as a smart contract code 422 of the asset sharing blockchain 200, and generate a computation result 423 based on data 321 of the asset sharing blockchain 200.

In some optional embodiments, the data 321, the smart contract code 322 and the computation result 323 are called by the same asset sharing blockchain 200, or the data 321, the smart contract code 322 and the computation result 323 are called by different asset sharing blockchains 200. That is, multiple asset sharing blockchains 200 may call the asset of the asset sharing blockchain 100, and, one asset sharing blockchain 200 may call one part of the asset of the asset sharing blockchain 100. Or, one asset sharing blockchain 200 may respectively call different assets of the multiple asset sharing blockchains 100. For example, the asset sharing blockchain 200 calls the data 321 of one asset sharing blockchain 100, and call the smart contract code 322 of the another asset sharing blockchain 100 to compute the called data 321.

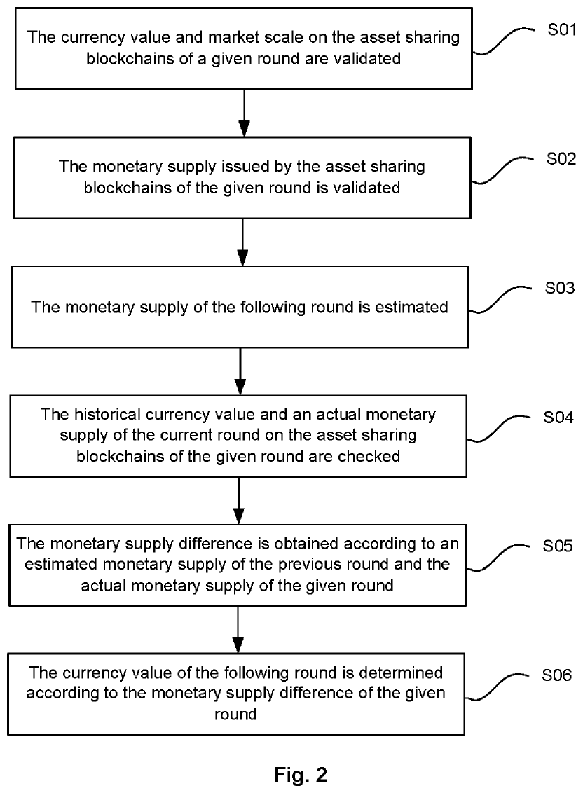

In some optional embodiments, asset sharing blockchains 100 and 200 have a currency value regulatory mechanism, so as to balance a currency value relationship with other asset sharing blockchains. Specifically, as shown in FIG. 2, FIG. 2 is a flow diagram of a currency value regulatory mechanism according to an embodiment of the present disclosure. A currency value is adjusted through a smart contract across chains. First, the currency value and market scale on the asset sharing blockchains 100 and 200 of a given round are validated (namely Step S01). The market scale is calculated using the value of an application asset uploaded to the asset sharing blockchain, this is known as an anchor point, or a basic asset for generating tokens. For example, when the application asset is an Internet cafe application asset, the anchor point may refer to an online time period of a user in the Internet cafe. That is, the computing asset (namely the basic asset) may be supplied by the user to the asset sharing blockchain, and the tokens provided by the asset sharing blockchain may be rewarded to the user. The market scale is then calculated from the online time period of the user. For example, it can be assumed that when the online time period is one hour, the market scale is equal to one token, such that when the online time period has accumulated to 10000 hours, the market scale will reach 10000 tokens.

Then, the monetary supply issued by the asset sharing blockchains 100 and 200 of the given round is validated (namely Step S02). At Step S03, the monetary supply of the following round is estimated. In the aforementioned internet cafe example, the monetary supply of the following round may be adjusted according to a proportion decided on the basis of scoring criteria of the Internet cafe, a current currency value and online hours of the Internet cafe of a current round. A mode of adjustment may be the adjustment positively related to at least one of the scoring criteria of the corresponding Internet cafe, the current currency value and the online hours of the Internet cafe of the current round.

Then, the historical currency value and an actual monetary supply of the current round on the asset sharing blockchains 100 and 200 of the given round are checked (namely Step S04). The monetary supply difference is obtained according to an estimated monetary supply of the previous round and the actual monetary supply of the given round (namely Step S05).

Finally, the currency value of the following round is determined according to the monetary supply difference of the given round (namely Step S06). In the aforementioned internet cafe example, the currency value of the following round may be: (the proportion decided on the basis of the scoring criteria of the Internet cafe*((the current currency value*the online hours of the Internet cafe of the current round)/(the current currency value*historical average hours))).

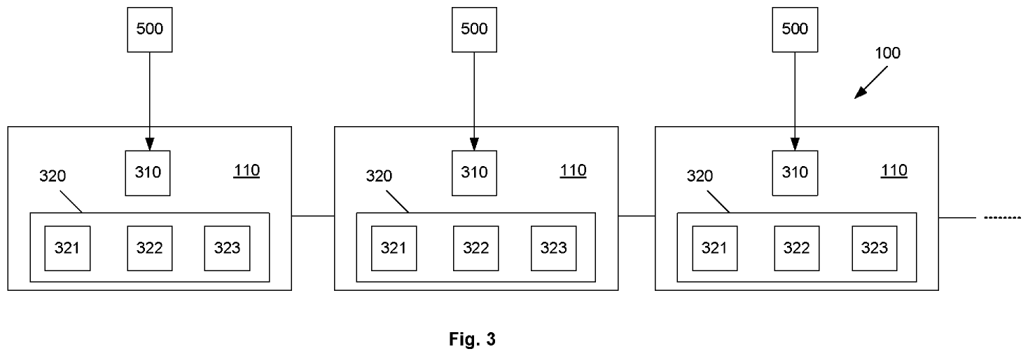

As shown in FIG. 3, FIG. 3 is a block diagram of an asset sharing blockchain according to the second optional embodiment of the present disclosure. The asset sharing blockchain may further receive data 500 from the outside and distributes the data 500 to the multiple nodes 110 to respectively compute part of the data 500. Thus, through computation distribution, a computation result may be obtained more effectively.

In some optional embodiments, each token on the asset sharing blockchain (namely, at least one of the asset sharing blockchain 100 and the asset sharing blockchain 200) has an exclusive code. Such that the properties and location of each issued token may be acquired by reference to this exclusive code present on the asset sharing blockchain. The exclusive code will be kept no matter how many transactions are implemented (even when the exclusive code is referenced across multiple asset sharing blockchains). Through the exclusive code, capital flow of all transactions on the chain may be validated, and each token may be validated by the current holder and all historical holders.

In summary, at least some embodiments of the present disclosure provide the asset sharing blockchain with the following capabilities: to provide the storage of data, smart contract code and computation results in a manner available for call by at least one other asset sharing blockchain; the ability to share a computing asset with at least one other asset sharing blockchain, so that development costs and the computing assets may be saved, and the authenticity of a data source and a code source may be ensured. In addition, the currency value may further be adjusted, so as to balance a currency value relationship between different asset sharing blockchains.

The technical contents of the present disclosure have been disclosed with exemplary embodiments above, but are not intended to limit the present disclosure. Several alterations and modifications made by those skilled in the art without departing from the spirit of the present disclosure should fall within the scope of the present disclosure. Therefore, for the scope of patent protection of the present disclosure, the scope defined by previous claims should prevail.

What is claimed is:

1. An asset sharing blockchain, comprising:
a plurality of nodes serially connected using blockchain technology, each node comprising an access interface available for call by another asset sharing blockchain and a repository storing data, a smart contract code and a computation result available for call by another asset sharing blockchain.

2. The asset sharing blockchain as claimed in claim 1, wherein the data, the smart contract code and the computation result are called by the same asset sharing blockchain, or the data, the smart contract code and the computation result are called by different asset sharing blockchains.

3. The asset sharing blockchain as claimed in claim 1, wherein the asset sharing blockchain receives data from the outside and distributes the data to the plurality of nodes to respectively compute part of the data.

4. The asset sharing blockchain as claimed in claim 1, wherein the asset sharing blockchain implements a currency value regulatory mechanism, comprising:
validating the currency value and market scale on the asset sharing blockchain of a given round;
validating the monetary supply issued by the asset sharing blockchain of the given round;
estimating the monetary supply of a following round;
checking the historical currency value and an actual monetary supply of a current round on the asset sharing blockchain of the given round;
obtaining the monetary supply difference according to an estimated monetary supply of the previous round and the actual monetary supply of the given round; and
determining the currency value of the following round according to the monetary supply difference of the given round.

5. The asset sharing blockchain as claimed in claim 1, wherein each token on the asset sharing blockchain has an exclusive code.

6. An asset sharing blockchain, comprising:
at least two blockchains, each of which comprises a plurality of nodes serially connected using blockchain technology, and each node comprises an access interface available for call by another asset sharing blockchain and a repository storing data, a smart contract code and a computation result available for call by another asset sharing blockchain.

7. The asset sharing blockchain as claimed in claim 6, wherein the data, the smart contract code and the computation result are called by the same asset sharing blockchain, or the data, the smart contract code and the computation result are called by different asset sharing blockchains.

8. The asset sharing blockchain as claimed in claim 6, wherein the asset sharing blockchain receives data from the outside and distributes the data to the plurality of nodes to respectively each compute a part of the data.

9. The asset sharing blockchain as claimed in claim 6, wherein the asset sharing blockchain implements a currency value regulatory mechanism, comprising:
validating the currency value and market scale on the asset sharing blockchain of a given round;
validating the monetary supply issued by the asset sharing blockchain of the given round;
estimating the monetary supply of the following round;
checking the historical currency value and an actual monetary supply of a given round on the asset sharing blockchain;
obtaining a monetary supply difference according to an estimated monetary supply of the previous round and the actual monetary supply of the current round; and
determining the currency value of the following round according to the monetary supply difference of the given round.

10. The asset sharing blockchain as claimed in claim 6, wherein each token on the asset sharing blockchain has an exclusive code.
